(19) United States
(12) Patent Application Publication
(10) Pub. No.: US 2025/0309331 A1
(43) Pub. Date: Oct. 2, 2025

(54) METHOD OF MANUFACTURING ALL-SOLID-STATE BATTERY

(71) Applicant: HONDA MOTOR CO., LTD., Tokyo (JP)

(72) Inventors: Yoshihiko Nakajima, Wako-shi (JP); Hideaki Sasaki, Wako-shi (JP); Keiichiro Oka, Wako-shi (JP); Takeshi Miyama, Wako-shi (JP); Masanori Ozawa, Wako-shi (JP)

(21) Appl. No.: 19/064,811

(22) Filed: Feb. 27, 2025

(30) Foreign Application Priority Data
Mar. 29, 2024 (JP) 2024-057644

(51) Int. Cl. H01M 10/04; H01M 10/0585; H01M 50/105; H01M 50/186; H01M 50/242

(52) U.S. Cl. CPC H01M 10/049; H01M 10/0585; H01M 50/105; H01M 50/186; H01M 50/242

(57) ABSTRACT

A method of manufacturing an all-solid-state battery is a method of manufacturing an all-solid-state battery including an electrode laminate and an exterior film configured to encase the electrode laminate, the method of manufacturing an all-solid-state battery including a process of encasing the electrode laminate with the exterior film, a process of sandwiching a region in the exterior film which is facing an outermost surface of the electrode laminate in a laminating direction and which is located at an inside edge portion of the outermost surface with holding members, and a process of sealing the exterior film in a state in which the exterior film is sandwiched between the holding members.

### CROSS-REFERENCE TO RELATED APPLICATION

Priority is claimed on Japanese Patent Application No. 2024-057644, filed Mar. 29, 2024, the content of which is incorporated herein by reference.

### BACKGROUND OF THE INVENTION

### Field of the Invention

The present invention relates to a method of manufacturing an all-solid-state battery.

### Description of Related Art

In recent years, research and development has been conducted into all-solid-state batteries that contribute to energy efficiency so that more people can have access to affordable, reliable, sustainable and advanced energy.

Since a volume of an all-solid-state battery fluctuates during charging and discharging, a pouch-type laminate is demanded to absorb displacement caused by expansion and contraction of battery cells. Currently, a structure exists in which an electrode laminate is wrapped in a laminate film with a cup height that is deeper than the thickness of the electrode laminate at EOL SOC 100%, and which has an extra length to absorb the displacement of the electrode laminate (for example, see Japanese Unexamined Patent Application, First Publication No. 2011-71133).

### SUMMARY OF THE INVENTION

If a laminate film presses down on an end portion of the electrode laminate after vacuum sealing, bending of the electrode laminate increases when the battery cell expands, and the stress generated in the solid electrolyte increases. As a result, a structural design becomes less robust.

An aspect of the present invention is directed to providing a method of manufacturing an all-solid-state battery capable of preventing an electrode laminate from bending more upon expansion of a battery cell by pressing a laminate film against the outermost surface of the electrode laminate. An aspect of the present invention is directed to contributing to stabilization of battery performance, improvement of quality control in a manufacturing process, and energy efficiency.

An aspect of the present invention provides the following method.

(1) A method of manufacturing an all-solid-state battery comprising an electrode laminate and an exterior film configured to encase the electrode laminate, the method of manufacturing an all-solid-state battery including:
a process of encasing the electrode laminate with the exterior film;
a process of sandwiching a region in the exterior film which is facing an outermost surface of the electrode laminate in a laminating direction and which is located at an inside edge portion of the outermost surface with holding members; and
a process of sealing the exterior film in a state in which the exterior film is sandwiched between the holding members.

By arranging the sealing part of the exterior film in the direction perpendicular to the laminating direction of the electrode laminate and providing voids between the exterior film and the electrode laminate along the edge portions of the outermost surface of the electrode laminate in the laminating direction, even if the exterior film presses against the outermost surface of the electrode laminate when the electrode laminate is covered with the exterior film, increased bending of the electrode laminate can be suppressed when the electrode laminate expands.

(2) The method of manufacturing an all-solid-state battery according to the above-mentioned (1), including a process of disposing a cushioning material in the region in the exterior film which is facing the outermost surface of the electrode laminate in the laminating direction and which is located at inside the edge portions of the outermost surface after the process of sealing the exterior film.

By providing the insulating layer, it is possible to prevent the electrode laminate and the exterior film from coming into contact with each other and the electrode laminate and the exterior film from being short-circuited. In addition, by disposing the above-mentioned voids in the vicinity of the insulating layer, it is possible to prevent a short circuit between the electrode laminate and the exterior film even if the exterior film and the insulating layer come into contact with each other due to expansion and contraction of the electrode laminate.

According to the aspect of the present invention, it is possible to provide an all-solid-state battery capable of preventing an electrode laminate from bending more upon expansion of a battery cell by pressing a laminate film against the outermost surface of the electrode laminate.

### BRIEF DESCRIPTION OF THE DRAWINGS

FIG. 1 is a cross-sectional view showing an all-solid-state battery according to an embodiment of the present invention.

FIG. 2 is a cross-sectional view showing a method of manufacturing an all-solid-state battery according to the embodiment of the present invention.

### DETAILED DESCRIPTION OF THE INVENTION

Hereinafter, a method of manufacturing an all-solid-state battery according to an embodiment of the present invention will be described with reference to the accompanying drawings.

[all-Solid-State Battery]

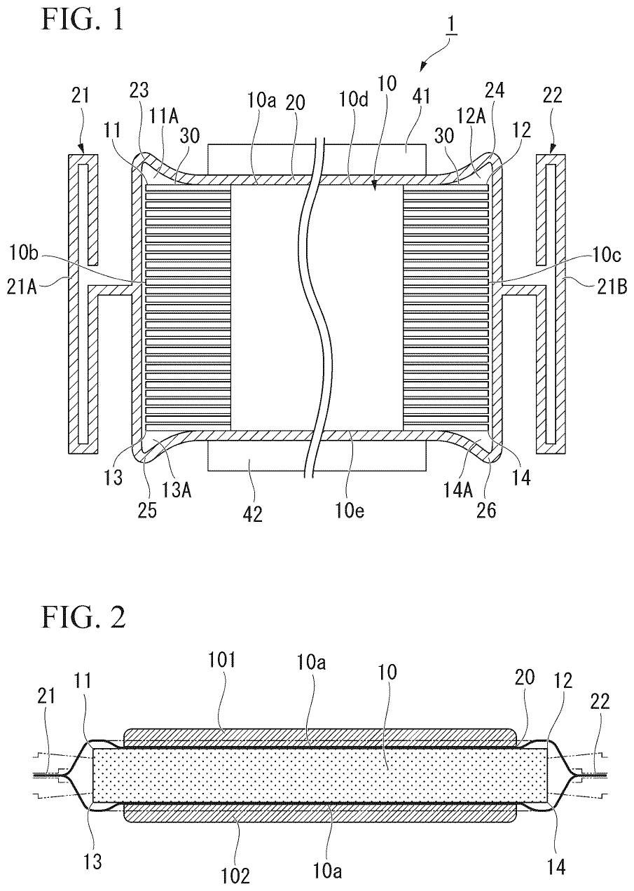

FIG. 1 is a cross-sectional view showing an all-solid-state battery according to an embodiment of the present invention. Further, the drawings used in the following description may show enlarged characteristic parts for the sake of convenience in order to make the features easier to understand, and dimensional ratios of each component are not limited to those shown in the illustrations.

As shown in FIG. 1, an all-solid-state battery 1 of the embodiment includes an electrode laminate 10, and an exterior film 20. The exterior film 20 covers an outer surface 10a of the electrode laminate 10 and also encases the electrode laminate 10.

The electrode laminate 10 has a positive electrode, a negative electrode, and a solid electrolyte layer.

The exterior film 20 has two sealing parts 21 and 22 disposed in a direction perpendicular to a laminating direction of the electrode laminate 10. That is, the sealing parts 21 and 22 are disposed to face side surfaces 10b and 10c of the electrode laminate 10 in the laminating direction, respectively. The sealing parts 21 and 22 are preferably folded over and have portions 21A and 22A that extend along the laminating direction of the electrode laminate 10. Accordingly, expansion and contraction of the electrode laminate 10 prevents the sealing parts 21 and 22 from being subjected to peeling forces.

Voids 11A, 12A, 13A and 14A are provided along edge portions 11, 12, 13 and 14 of the outermost surface of the electrode laminate 10 in the laminating direction (an upper surface 10d of the electrode laminate 10 in the laminating direction and a lower surface 10e of the electrode laminate 10 in the laminating direction) between the edge portions 11, 12, 13 and 14 of the outermost surface of the electrode laminate 10 in the laminating direction and the exterior film 20. By providing the voids 11A, 12A, 13A and 14A, there are extra lengths 23, 24, 25 and 26 of the exterior film 20 along the edge portions 11, 12, 13 and 14 of the outermost surface of the electrode laminate 10 in the laminating direction.

The extra lengths 23, 24, 25 and 26 of the exterior film 20 refer to areas of the exterior film 20 that are separated from the electrode laminate 10 without contacting the electrode laminate 10. The lengths of the extra lengths 23, 24, 25 and 26, i.e., the lengths of the exterior film 20 separated from the electrode laminate 10 are preferably 1 mm or more and 3 mm or less, more preferably 1 mm or more and 1.5 mm or less. When the lengths of the extra lengths 23, 24, 25 and 26 are within this range, the entire exterior film 20 being stretched and a peeling force on the sealing parts 21 and 22 being exerted can be prevented by the expansion and contraction of the electrode laminate 10. In addition, the length of the exterior film 20 separated from the electrode laminate 10 is a maximum length of the voids 11A, 12A, 13A and 14A in a thickness direction of the all-solid-state battery 1.

The all-solid-state battery 1 preferably includes an insulating layer 30 configured to cover the side surfaces 10b and 10c of the electrode laminate 10 in the laminating direction. Further, the voids 11A, 12A, 13A and 14A are preferably disposed in the vicinity of the insulating layer 30. In other words, the extra lengths 23, 24, 25 and 26 of the exterior film 20 are preferably disposed in the vicinity of the insulating layer 30. By providing the insulating layer 30, it is possible to prevent the electrode laminate 10 and the exterior film 20 from coming into contact with each other and causing a short circuit between them. In addition, by arranging the voids 11A, 12A, 13A and 14A in the vicinity of the insulating layer 30, even if the exterior film 20 and the insulating layer 30 come into contact with each other due to expansion and contraction of the electrode laminate 10, it is possible to prevent a short circuit between the electrode laminate 10 and the exterior film 20.

It is preferable that cushioning materials 41 and 42 are arranged on the outermost surface of the electrode laminate 10 in the laminating direction (the upper surface 10d of the electrode laminate 10 in the laminating direction and the lower surface 10e of the electrode laminate 10 in the laminating direction) inside the voids 11A, 12A, 13A and 14A, in other words, inside the extra lengths 23, 24, 25 and 26 of the exterior film 20. By providing the cushioning materials 41 and 42, damage to the electrode laminate 10 can be prevented when an external force is applied.

### (Positive Electrode)

The positive electrode has a first current collector layer, and a first active material layer containing at least a positive electrode active material, which are laminated. In the embodiment, the positive electrode has a first current collector layer, and first active material layers formed on both main surfaces of the first current collector layer.

The first current collector layer is preferably formed of at least one material with high conductance.

As the material with high conductivity, for example, a metal or alloy containing at least one metal element of silver (Ag), palladium (Pd), gold (Au), platinum (Pt), aluminum (Al), chromium (Cr), and nickel (Ni), or a non-metal of carbon (C) is exemplified. Considering a manufacturing cost as well as a conductivity height, aluminum, nickel or stainless steel is preferred. Further, the aluminum does not easily react with the positive electrode active material and electrolyte. For this reason, when the aluminum is used in the first current collector layer, the internal resistance of the battery can be reduced.

The shape of the first current collector layer can be, for example, a foil shape, a plate shape, a mesh shape, a non-woven fabric shape, a foam shape, or the like. In addition, in order to improve adhesion with a first active material layer 32, carbon or the like may be disposed on the surface of the first current collector layer, or the surface may be roughened.

The first active material layer contains a positive electrode active material that transfers lithium ions and electrons. There are no particular limitations on the positive electrode active material, so long as it can reversibly release and absorb lithium ions and is suitable for electron transportation, and any known positive electrode active material that can be applied to the positive electrode of the lithium ion battery can be used. For example, complex oxides such as lithium cobalt oxide (LiCoO₂), lithium nickel oxide (LiNiO₂), lithium manganese oxide (LiMn₂O₄), solid solution oxide (Li₂MnO₃—LiMO₂ (M=Co, Ni, etc.)), lithium-manganese-nickel-cobalt oxide (LiNiₓMn_{y}Co_{z}O₂, x+y+Z=1), olivine-type lithium phosphate oxide (LiFePO₄), and the like; conductive polymers such as polyaniline, polypyrrole, and the like; sulfides such as Li₂S, CuS, Li—Cu—S compounds, TiS₂, FeS, MoS₂, and Li—Mo—S compounds; and mixtures of sulfur and carbon are exemplified. The positive electrode active material may be composed of one of the above materials alone or two or more of them.

The first active material layer contains a positive electrode active material and an electrolyte that transfers lithium ions. There are no particular limitations on the electrolyte as long as it has lithium ion conductivity, and any material generally used for lithium ion batteries can be used. As the electrolyte, for example, inorganic solid electrolytes such as a sulfide solid electrolyte material, an oxide solid electrolyte material, a halide solid electrolyte, lithium-containing salts, and the like, polymer-based solid electrolytes such as polyethylene oxide and the like, gel-based solid electrolytes such as lithium-containing salts or ion liquid with lithium ion conductivity, or the like, can be exemplified. Among these, sulfide solid electrolyte materials are preferred from the viewpoints of the high conductive properties of lithium ions, as well as favorable structural formability or interface bonding by pressing.

The electrolyte may be composed of one of the above materials alone, or may be composed of two or more of them. The electrolyte contained in the first active material layer may be the same material as the electrolyte contained in the second active material layer or the solid electrolyte layer, or it may be a different material.

The first active material layer may contain a conductive additive from the viewpoint of improving the conductivity of the positive electrode. As the conductive additive, any conductive additive that can be used in lithium ion batteries can be used. For example, carbon black such as acetylene black, ketjen black, or the like; carbon fiber; vapor grown carbon fiber; graphite powder; and a carbon material such as carbon nanotube or the like can be exemplified. The conductive additive may be composed of one of the above materials alone, or two or more of them.

In addition, the first active material layer may contain the positive electrode active materials, and a binder that serves to bind the positive electrode active materials and the first current collector layer.

In the embodiment, the first active material layer may be formed on both main surfaces of the first current collector layer but not limited thereto or may be formed on only one main surface of the first current collector layer. In addition, when the positive electrode is a single-sided coated electrode, a laminated positive electrode with two positive electrodes laminated to align their current collector surfaces may be used as a double-sided coated electrode. In addition, when the first current collector layer has a three-dimensional porous structure such as a mesh shape, a non-woven fabric shape, a foam shape, etc., the first current collector layer may be provided integrally with the first active material layer.

The first current collector layer is assembled at one end portion of the all-solid-state battery in the widthwise direction.

Since the first active material layer is in contact with the solid electrolyte layer, it may contain sulfide contained in the solid electrolyte layer.

### (Negative Electrode)

The negative electrode has the second current collector layer, and a second active material layer containing at least a negative electrode active material, which are laminated. In the embodiment, the negative electrode has the second current collector layer, and the second active material layer formed on both main surfaces of the second current collector layer and containing the negative electrode active material and electrolyte.

The second current collector layer contains at least copper (Cu). The second current collector layer, like the first current collector layer, may contain a material other than copper that has high conductance. The materials other than copper that have high conductivity include, for example, metals or alloys that contain at least one of metal elements of silver (Ag), palladium (Pd), gold (Au), platinum (Pt), chromium (Cr) and nickel (Ni), or non-metals such as carbon (C). Considering the manufacturing cost as well as the conductivity height, nickel or stainless steel is preferable as a material other than copper. Further, the stainless steel does not react easily with the positive electrode active material, the negative electrode active material and the electrolyte. For this reason, using stainless steel for the second current collector layer can reduce the manufacturing costs of the battery.

The shape of the second current collector layer can be, for example, a foil shape, a plate shape, a mesh shape, a non-woven fabric shape, a foam shape, etc. In addition, in order to improve adhesion with the second active material layer, carbon or the like may be disposed on the surface of the second current collector layer, or the surface may be roughened.

The second active material layer contains a negative electrode active material that transfers lithium ions and electrons. There are no particular limitations on the negative electrode active material, as long as it can reversibly release and absorb lithium ions and is suitable for electron transportation, and any known negative electrode active material that can be applied to the negative electrode of the lithium ion battery can be used. For example, a carbon material such as natural graphite, artificial graphite, resin charcoal, carbon fiber, activated charcoal, hard carbon, soft carbon, or the like; an alloy-based material mainly made of tin, tin alloy, silicon, silicon alloy, gallium, gallium alloy, indium, indium alloy, aluminum, aluminum alloy, or the like; a conductive polymer such as polyacene, polyacetylene, polypyrrole, or the like; metal lithium; and a lithium alloy such as lithium titanium composite oxide (for example, Li₄Ti₅O₁₂) or the like are exemplified. These negative electrode active materials may be composed of one of the above materials alone, or may be composed of two or more of them.

The second active material layer contains the negative electrode active material, and an electrolyte that transfers lithium ions. There are no particular limitations on the electrolyte as long as it has lithium ion conductivity, and any material generally used for lithium ion batteries can be used. As the electrolyte, for example, an inorganic solid electrolyte such as a sulfide solid electrolyte material, an oxide solid electrolyte material, a halide solid electrolyte, lithium-containing salts, or the like, a polymer-based solid electrolyte such as polyethylene oxide or the like, a gel-based solid electrolyte containing lithium-containing salts or ion liquid with lithium ion conductivity, or the like, can be exemplified. The electrolyte may be composed of one of the above materials alone, or may be composed of two or more of them.

The electrolyte contained in the second active material layer may be the same as or different from the electrolyte contained in the first active material layer or the solid electrolyte layer.

The second active material layer may contain conductive additives and binders. There are no particular limitations on these materials, but for example, materials similar to those used for the first active material layer described above can be used.

In the embodiment, the second active material layer may be formed on both main surfaces of the second current collector layer but not limited thereto, or may be formed on only one main surface of the second current collector layer. In addition, when the second current collector layer has a three-dimensional porous structure such as a mesh shape, a non-woven fabric shape, a foam shape, etc., the second current collector layer may be provided integrally with the second active material layer.

### (Solid Electrolyte Layer)

The solid electrolyte layer is disposed between the first active material layer and the second active material layer.

There are no particular limitations on the electrolyte as long as it has lithium ion conductivity and insulating properties, and any material generally used for lithium ion batteries can be used. For example, an inorganic solid electrolyte such as a sulfide solid electrolyte material, an oxide solid electrolyte material, a halide solid electrolyte, a lithium-containing salts, or the like, a polymer-based solid electrolyte such as polyethylene oxide, or the like, a gel-based electrolyte containing lithium-containing salts or ion liquid with lithium ion conductivity, or the like, can be exemplified. Among these, sulfide solid electrolyte materials are preferred from the viewpoints of the high conductive properties of lithium ions, as well as favorable structural formability and interface bonding by pressing.

The form of the electrolyte material is not particularly limited, but may be, for example, in the form of particles.

The solid electrolyte layer may contain an adhesive to impart mechanical strength and flexibility.

The solid electrolyte layer may be in the form of a sheet having a porous substrate and a solid electrolyte held on the porous substrate. The form of the porous substrate is not particularly limited, and examples include woven fabric, non-woven fabric, mesh cloth, porous membrane, expanded sheet, punched sheet, etc. Among these forms, the non-woven fabric is preferred from the viewpoint of handling, which allows a higher loading amount of the solid electrolyte to be achieved.

The porous substrate is preferably composed of an insulating material. Accordingly, it is possible to improve insulation properties of the solid electrolyte layer. As the insulating material, for example, nylon, polyester, polyethylene, polypropylene, polytetrafluoroethylene, ethylene-tetrafluoroethylene copolymer, polyvinylidene fluoride, polyvinylidene chloride, polyvinyl chloride, polyurethane, vinylon, polybenzimidazole, polyimide, polyphenylene sulfite, polyether ether ketone, cellulose, resin materials such as acrylic resin or the like; natural fibers such as hemp, wood pulp, and cotton linters, glass, and the like, are exemplified.

### (Exterior Film)

The exterior film 20 is a laminated film having an inner resin layer, a metal layer, and an outer resin layer. As the resin that constitutes the inner resin layer and the outer resin layer, for example, polyester resins such as polyethylene terephthalate (PET) or the like is exemplified. The metal layer is constituted by, for example, aluminum foil or the like.

### (Insulating Layer)

As the insulating material that constitutes the insulating layer 30, although not particularly limited, examples include high purity alumina or the like.

### (Cushioning Material)

The cushioning materials 41 and 42 are not particularly limited, but may be made of materials having, for example, thermal conductivity and elasticity.

[Method of Manufacturing all-Solid-State Battery]

A method of manufacturing an all-solid-state battery according to the embodiment of the present invention is a method of manufacturing an all-solid-state battery including an electrode laminate and an exterior film configured to encase the electrode laminate, the method includes a process of encasing the electrode laminate with the exterior film (hereinafter, referred to as “a first process”), a process of sandwiching a region in the exterior film which faces the outermost surface of the electrode laminate in the laminating direction and which is located at inside an edge portion of the outermost surface using holding members (hereinafter, referred to as “a second process”), and a process of sealing the exterior film in a state in which the exterior film are sandwiched by the holding members (hereinafter, referred to as “a third process”).

Referring to FIG. 1 and FIG. 2, the method of manufacturing an all-solid-state battery of the embodiment will be described.

### (First Process)

In the first process, the electrode laminate 10 is encased with the exterior film 20.

### (Second Process)

In the second process, as shown in FIG. 2, the region in the exterior film 20 which is facing the outermost surface 10a of the electrode laminate 10 in the laminating direction and which is located at inside the edge portions 11, 12, 13 and 14 of the outermost surface 10a is sandwiched between holding members 101 and 102. Accordingly, voids are provided along the edge portions 11, 12, 13 and 14 of the outermost surface 10a of the electrode laminate 10 in the laminating direction between the exterior film 20 and the electrode laminate.

### (Third Process)

In the third process, the exterior film 20 is sealed in a state in which the exterior film 20 is sandwiched by the holding members 101 and 102. When the exterior film 20 is sealed, the two sealing parts 21 and 22 disposed in the direction perpendicular to the laminating direction of the electrode laminate 10 are formed. Further, the sealing parts 21 and 22 are folded back to form the portions 21A and 22A that extend in the laminating direction of the electrode laminate 10.

### (Fourth Process)

The method of manufacturing an all-solid-state battery of the embodiment preferably has a process of disposing the cushioning materials 41 and 42 in the region in the exterior film 20 which is facing the outermost surface 10a in the laminating direction of the electrode laminate 10 and which is located at inside the edge portions 11, 12, 13 and 14 of the outermost surface 10a, after the process of sealing the exterior film 20 (the third process).

The all-solid-state battery 1 of the embodiment is obtained by the above-mentioned processes.

According to the method of manufacturing an all-solid-state battery of the embodiment, by arranging the sealing parts 21 and 22 of the exterior film 20 in the direction perpendicular to the laminating direction of the electrode laminate 10, and providing the voids between the exterior film 20 and the electrode laminate along the edge portions of the outermost surface of the electrode laminate 10 in the laminating direction, even if the exterior film 20 presses against the outermost surface of the electrode laminate 10 when the electrode laminate 10 is covered with the exterior film 20, an increase in the bending of the electrode laminate 10 when the electrode laminate 10 expands can be suppressed.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A method of manufacturing an all-solid-state battery comprising an electrode laminate and an exterior film configured to encase the electrode laminate, the method of manufacturing an all-solid-state battery comprising:
a process of encasing the electrode laminate with the exterior film;
a process of sandwiching a region in the exterior film which is facing an outermost surface of the electrode laminate in a laminating direction and which is located at an inside edge portion of the outermost surface with holding members; and
a process of sealing the exterior film in a state in which the exterior film is sandwiched between the holding members.

2. The method of manufacturing an all-solid-state battery according to claim 1, comprising a process of disposing a cushioning material in the region in the exterior film which is facing the outermost surface of the electrode laminate in the laminating direction and which is located at inside the edge portions of the outermost surface after the process of sealing the exterior film.
